(19) United States
(12) Patent Application Publication
(10) Pub. No.: US 2002/0065894 A1
(43) Pub. Date: May 30, 2002

(54) Local presence state and user-controlled presence and message forwarding in unified instant messaging

(76) Inventors: Siddhartha R. Dalal, Bridgewater, NJ (US); Hyong Sop Shim, Basking Ridge, NJ (US); John R. Wullert II, Martinsville, NJ (US)

Correspondence Address: Joseph Giordano, Esq., Telcordia Technologies, Inc., Room 1G112R, 445 South Street, Morristown, NJ, 07960, US

(21) Appl. No.: 09/726,913

(22) Filed: Nov. 30, 2000

Related U.S. Application Data
(60) Provisional application No. 60/168,881, filed on Dec. 3, 1999.

(51) Int. Cl. G06F 15/16

(52) U.S. Cl. 709/206; 709/204

(57) ABSTRACT

An instant messaging communication system wherein users can obtain instant messaging at different terminal devices, in accordance with information they priorly store in a user defined terminal selection store in a unified instant messaging processor. The unified instant messaging processor also stores user preference data. Data from users arrives at the unified instant messaging processor directly over the internet, while an instant messaging client communicates with the unified instant messaging processor through a presence and messaging processor. The data may include either message data or presence data, and a processor in the unified instant message processor determines the handling of the data, with reference to information prior stored by a user, and enables appropriate formatting and routing of the information.

### RELATED APPLICATION

This application claims the benefit of U.S. Provisional Application No. 60/168,881, filed Dec. 3, 1999.

### FIELD OF THE INVENTION

This invention relates to communication systems and more particularly such systems employing instant messaging.

### BACKGROUND OF THE INVENTION

Communication users, particularly those employing networked computers, currently have certain facilities available to them to enhance their communication uses. One such facility is known as instant messaging which allows networked computer users to keep track of the online availability of other users, such as friends, business associates, family members, and people with shared interests, and instantly communicate with those who are available. Users whose online availability is tracked by another user are collectively called the users buddies, and keeping track of the online availability of buddies is called presence management. In instant messaging, the communications between buddies is in real time through text or voice messages. The communications can be between two or more buddies. Therefore instant messaging can support functionality similar to paging, conferencing, and personal networking. Paging or ringing functionality is supported by getting the attention of users who are registered but engaged in some other activity. Conferencing allows multiple people to participate in a combined communication. Users can create a personal network using search engines to locate others with similar backgrounds and/or interest. Current instant messaging systems use presence servers, but these are limited in that they do not all support the variety of terminal devices that may be employed by a customer of the service.

Another present facility to enhance communications is unified messaging. Unified messaging, where users can retrieve and transmit messages without regard to the original or final format of the data, is a popular business service, particularly with mobile business users. In unified messaging, communications in a variety of forms pass through a central server that can translate messages from one form to another and take a specific action for a message. The action the central server takes is based on factors such as the time of day, day of week, and content, source, format or destination of the message.

### SUMMARY OF THE INVENTION

In accordance with our invention, communications between users is further enhanced by combining the presence management and interactive communication of instant messaging with the message translation of unified messaging to form a new facility which we refer to as unified instant messaging. Our invention thus allows users of instant messaging services to participate even when they are away from their computer terminals, using communication devices of their choice, e.g., pagers, cell-phones, and PDAs.

A system, in accordance with our invention, can provide presence and instant messaging capabilities similar to those of existing instant message client applications. In order to receive the presence and instant messaging services, a user runs the unified instant message messenger application of our invention on his or her computer and logs in to a server. At this point, the process of our invention behaves much in the same way as a messenger process does, in that it displays the online availability of the user's buddies and allows the user to receive and initiate an instant messaging session with a buddy. However, in addition our invention allows a user to define both global and local presence states. The user can assume any of the presence states defined in an existing instant message service, i.e., online, offline, and hidden, as his or her global presence state.

Further, a system in accordance with our invention allows a user to define his or her local presence state in a variety of values, such as None, Pageable, or Emailable. These values specify how and where a user wishes to be contacted. The local presence state only applies when the global presence state is online. If the local presence state is set to None, the user does not wish to be contacted by instant messaging when away from his or her computer terminal. Thus in the None state, our system functions much like existing instant message systems.

States other than None indicate that the user wishes to be contacted by instant messaging when away from his or her computer terminal. These local presence states allow the user to specify an autoreply instant message. This message is automatically sent to the senders of instant messages received in either state. With autoreply messages, the user can indicate his or her expected message capabilities at remote locations, e.g., “Please wait, and “I'll reply to your message in a moment” in the Emailable state.

In active local states, such as Pageable, the user can also specify whether or not the user wishes to be notified of updates to the online availability of his or her buddies. If the user so wishes, a presence notification message is sent to the destination device of the user's choice whenever updates occur on the online availability of his or her buddies.

In the Pageable state, the user wishes to receive instant messages on his or her pager. The Pageable state is part of a category of states that implies that the user would not be able to reply to the instant message that the user receives. With our invention, the instant messages received in the Pageable state can be transformed to the email address that the user has specified in his or her Pageable state profile. Other alternatives are possible also, e.g., use of Simple Network Paging Protocol (SNPP), Telelocator Alphanumeric Protocol (TAP), FAX, or Text to Speech (TTS).

In the Emailable state, the user wishes to receive instant messages as email. Unlike the Pageable state, the Emailable state implies that the user would reply to the messages he or she receives. That is, upon receiving an instant message as an email the user replies to the message. Then the email reply message is directly received in our system, which transforms the email to an instant message and sends it to the user's buddies in the current instant messaging session. Note that no periodic polling of an email inbox is necessary, which expedites the process of email reply messaging. However, in place of email messaging, other alternatives can be used with our invention, such as Short Message Service (SMS), Wireless Application Protocol (WAP), or Text to Speech with speech recognition.

### DESCRIPTION OF THE DRAWINGS

FIG. 1 is a schematic representation of one illustrative embodiment of a unified instant message system in accordance with our invention.

FIG. 2 is a flow diagram illustrating one aspect of the method of our invention.

### DETAILED DESCRIPTION

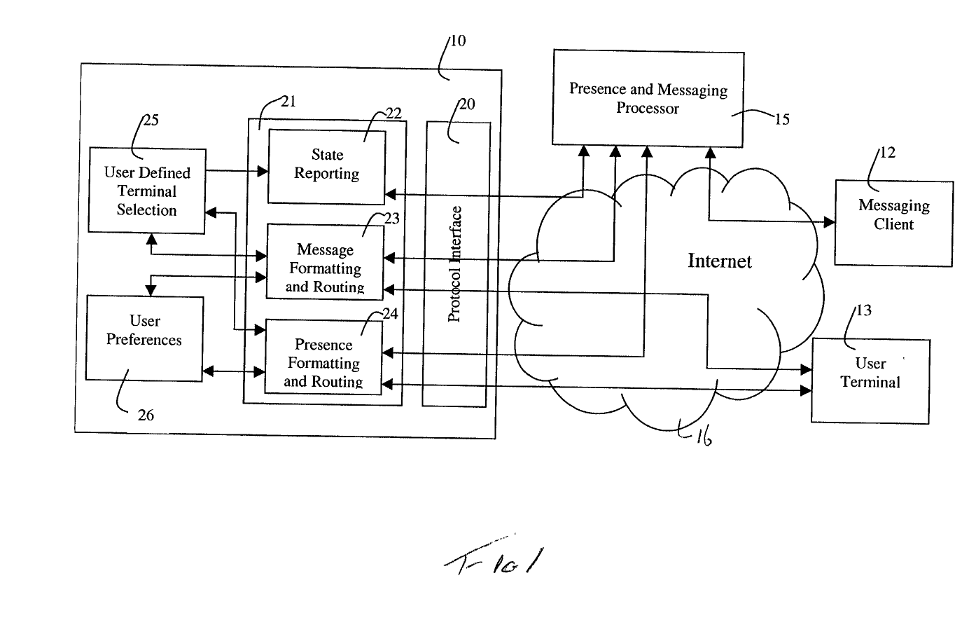

Turning now to FIG. 1, our system includes a unified instant messaging processor (UIM) 10, in accordance with our invention. The UIM 10 communicates, through the internet 16, with a plurality of terminals 13 for a user, of which only one terminal is depicted. The user terminals 13 may include cell phones, computers, etc., as is known in the art. Also communicating with the UIM 10 is a presence and messaging processor or presence server 15, also known in the art as an instant messenger server (IMS), which communicates with messaging clients 12. Both the instant messenger clients 12 and the instant messenger server 15 are based on software currently available. When the local presence state, as discussed below, is set to None, the default state, our UIM 10 functions like the messenger client 12. It can connect to messenger servers, such as presence and messaging processor 15, receive and display its users' presence data from the servers, and exchange instant messages with other systems.

The UIM processor includes a processor 21 that communicates with the user terminals and the presence server 15 through protocol interface 20, the communication with the messaging client being through the presence server 15. However, the user terminals 13 communicate directly through the internet 16 with the UIM processor 10. The presence and messaging processor forwards to a state reporting entity 22 in the processor 21 within the UIM 10 indications of state transitions of buddies of the user. Processor 21 also includes a message formatting and routing entity 23 and a presence formatting and routing entity 24. Also included in the UIM 10 are data stores 25 and 26. Store 25 stores the user defined terminal selection, i.e., the user defined local presence state, such as at email, at page, at phone, off-line, etc. User preference store 26 stores the identification of the data types to be forwarded, the user messages to forward for autoreply, etc.

Upon user activation, the UMI 10 prompts the user for a local state, e.g., pageable, email, etc. The UMI 10 then reports the user global state, i.e., on line, to the presence and messaging processor using a protocol specific to the presence and processing messaging processor 15. At this point, the presence and messaging processor 15 will deliver to the UMI 10 status information for all of the user's buddies. Note that when the user's local presence state is defined, his or her global presence state could be augmented so that it also reflects the user's local presence state, e.g., “John is on line (email)” where “online” is John's global presence state and “email” is John's local presence state. Doing so allows the user's buddies to more accurately access the presence state. Doing so allows the user's buddies to more accurately access the online availability of the user. In the above example, John's buddies would not only know that John is still online and available for communications but also could tell that communications with John would be slower than usual because of the email. Being able to use both local and global presence states, in accordance with our invention, thus enhances the usability of the instant messaging.

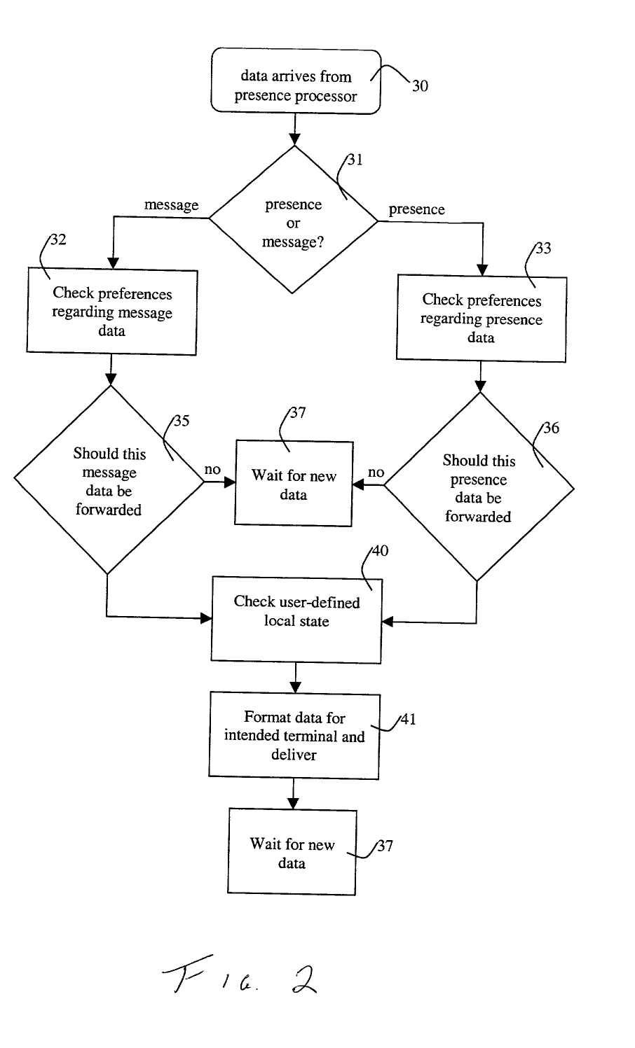

As seen in the flow diagram of FIG. 2, at event 30 data received from a messaging client 12 is forwarded by the presence processor 15 through the protocol interface 20 to the processor 21 in the UIM 10. At step 31 processor 21 determines whether the data concerns a message or a presence. If a message, message formatting and routing entity 23 checks with the user preference store 26, at step 32 to determine, at step 35, whether this message should be forwarded. Similarly, if the data is determined to be a presence, the presence formatting and routing entity 24 checks, at step 33, with the user preference store 26, to determine, at step 36 whether the presence data should be forwarded. If either step 35 or step 36 results in a determination that the data is not to be forwarded, the process, at step 37, proceeds to wait for new data, i.e., it gets ready to return to event 30.

When it is determined, in step 35 or step 36, that data is to be forwarded the respective formatting and routing entity 23 or 24 checks the user defined terminal selection store 25 to determine the user defined local state for that data, step 40. The entity 23 or 24 then formats the data and delivers it through the protocol interface 20 to the user terminal 13 selected. The process then returns to event 30 to wait for new data, step 37.

The UIM processor 10, in accordance with our invention, thus allows a user to be reached via instant messaging even when the user is away from his or her computer terminal, the user specifying, by means of the store 25 in the UIM 10, how the user can be contacted when away from that terminal. Therefore the UIM distinguishes messaging service, a user's global presence indicates the user's online availability to the user's buddies. In contrast, a user's local presence state applies only when the user is away from his or her computer terminal and indicates whether or not the user wishes to be contacted when away from that terminal. In addition, the user's local presence state indicates how the user wishes to be contacted, e.g., voicemail, email, or page, or may include autoreply messages.

When a user wishes to receive instant messages away from his or her computer terminal, the instant messages should be forwarded to the destination device of the user's choice both in real time and in a format understandable by that chosen device. Such formatting or translating, as based on the user's specification of the local presence state in store 25, is done by the message formatting element 23.

When a user wishes to monitor the online state of his or her buddies but the user is away from his or her computer terminal, presence data can be forwarded to the destination device of the user's choice. As with instant messages, the presence data should be formatted in real time, by the presence formatting element 24, so that it can be understood by that chosen destination device. In addition, the user can individually select buddies whose online presence state he or she wishes to keep track of from that remote location.

In one specific embodiment of our invention that we have implemented, the UIM processor 10 was developed as a Java application and was based on Microsoft Messenger service protocol. When its local presence state is set to None, the default state, our UIM processor 10 functions much like the Microsoft Messenger client. It can connect to the Messenger servers, receive and display presence data of buddies from the servers, and exchange instant messages with other UMI processors and Messenger clients. However, in the Pageable state, our UIM processor 10 functions as follows. When it receives an instant message from its user's buddy, the UIM processor first creates a pager message that contains the text content of the instant message as its body. It then sends the pager message to the message formatting and routing entity 23, which can then send a user-specified autoreply message to the instant message sender. Further, the messenger client 12 may be either a UIM or a Microsoft messenger client.

In the Emailable state, the UIM processor 10 functions similarly to when it is in the Pageable state, except that it now expects to receive email replies from its user. When creating an email message from an instant message, the UIM processor 10 includes the host name of the host machine on which it is running, so that replies can be delivered directly to the UIM processor. In order to support multiple messaging sessions, the unified instant messaging processor 10 advantageously also includes information used to correlate any replies to the user.

When the UIM processor 10 receives an email reply it checks the correlation information to determine which instant messaging session the reply is for and it creates an instant message that conforms to Messenger Service protocol. The body of the email reply becomes the text content of the instant message. Subsequently, the UIM processor 10 broadcasts the instant message to participants in the current instant messaging session by sending the message to its connected presence processor 15.

The UIM processor 10 in accordance with our invention enables email communication directly between the UIM 10 and user terminals 13 without the need for a separate mail server. Specifically, the UIM 10, and advantageously by means of the protocol interface 20 in the UIM 10, can run a Simple Mail Transport Protocol (SMTP).

The above description is exemplary of our invention. Numerous modifications and variations may be made by those skilled in the art without departing from the spirit and scope of our invention. For example, the UIM processor 10 could be a central server for a plurality of users, each having a plurality of different terminals.

What we claim is:

1. An instant messaging communication system that enables a user to obtain instant messaging at destination devices other than the user's normal terminals, said system comprising
a presence processor,
a messenger client connected to said presence processor, and
a unified instant messaging processor communicating with said presence processor and with said user terminals, said unified instant message processor including
means for storing user defined terminal selections and for storing user preferences, and
a further processor connected to said storing means and comprising state reporting means for receiving from said unified instant message processor information as to the user defined local presence states and means for formatting and routing data in communication with said presence processor.

2. A system in accordance with claim 1 wherein said means for formatting and routing data comprises means for formatting and routing message data and means for formatting and routing presence data.

3. A system in accordance with claim 2 wherein said unified messaging processor further comprises a protocol interface between said further processor and said presence processor.

4. A system in accordance with claim 2 wherein communication between said unified messaging processor and said presence processor, between said messenger client and said presence processor, and between said user terminals and said unified instant messaging processor is via the internet.

5. An instant messaging communication system in accordance with claim 1 wherein said unified instant messaging processor is a central server for a plurality of users, each of said plurality of users having a plurality of different terminals.

6. A method for enabling instant messaging with a user at different locations for that user, said method including the steps of
transmitting data from a presence processor to a unified instant message processor,
at said unified instant message processor determining whether said data concerns a presence or a message,
based upon said determining step checking with prior stored information as to whether said data should be forwarded,
if said data is to be forwarded, checking prior stored information as to the local presence state for said data; and
formatting and routing said data to the intended terminal, as determined from said local presence state for said data.

7. The method in accordance with claim 6 further enabling a user to reply to a forwarded instant message and wherein said formatting and routing step comprises including within the forwarded message a specific return address including correlation information, and said method further comprising the steps of
monitoring said return address for a reply from the user terminal,
accepting the reply from a user terminal, correlating the reply with a proper instant messaging session, and translating the reply into a format acceptable to the presence processor, and
delivering the reply to the proper instant messaging session on the presence processor.

8. The method in accordance with claim 7 wherein communication between the unified instant message processor and a user terminal is via email.

9. The method in accordance with claim 8 wherein said unified instant message processor runs a Simple Mail Transport Protocol process and creates dynamic email addresses to do correlation.

10. The method in accordance with claim 6 further comprising the step of registering with the presence processor on behalf of a user.

11. The method in accordance with claim 10 wherein said registering step comprises the steps of
the unified instant message processor prompting the user for a local state,
the unified instant message processor reporting the user global state to the presence processor, and
the presence processor delivering to the unified instant messaging processor status information for buddies of the user.
